(19) United States
(12) Patent Application Publication
(10) Pub. No.: US 2025/0232714 A1
(43) Pub. Date: Jul. 17, 2025

(54) METHOD AND SYSTEM FOR CORRECTING NONUNIFORMITY OF NEAR-EYE DISPLAY

(71) Applicant: JADE BIRD DISPLAY (SHANGHAI) LIMITED, SHANGHAI (CN)

(72) Inventors: Kuoyuan SUN, Shanghai (CN); Xingtong JIANG, Shanghai (CN); Jinxu WANG, Shanghai (CN)

(21) Appl. No.: 19/012,908

(22) Filed: Jan. 8, 2025

(30) Foreign Application Priority Data
Jan. 11, 2024 (WO) PCT/CN2024/071770

(51) Int. Cl. G09G 3/32; G06T 3/40; G06T 7/00; G06T 7/90; H04N 13/15; H04N 13/327; H04N 13/339; H04N 13/344

(52) U.S. Cl. CPC G09G 3/32; G06T 3/40; G06T 7/0002; G06T 7/90; H04N 13/15; H04N 13/327; H04N 13/344; G06T 2207/10024; G09G 2320/0233; G09G 2320/0242; G09G 2320/0666; G09G 2320/0693; G09G 2340/0407; G09G 2360/16; H04N 13/339

(57) ABSTRACT

A method for correcting nonuniformity of a near-eye display (NED), including: generating and displaying a first plurality of test patterns for a display of the NED; obtaining, in response to the first plurality of test patterns, a first plurality of images at an end of an optical path coupled to the display; fitting a mapping relationship for each of display pixels of the display according to the first plurality of test patterns and the first plurality of images, the mapping relationship of a display pixel mapping the display pixel and a corresponding image pixel in each image of the first plurality of images; and determining a correction scheme for correcting nonuniformity of the NED based on the mapping relationship of each of the display pixels.

### CROSS-REFERENCE TO RELATED APPLICATIONS

This disclosure claims the benefits of priority to PCT Application No. PCT/CN2024/071770, filed on Jan. 11, 2024, which is incorporated herein by reference in its entirety.

### TECHNICAL FIELD

The present disclosure generally relates to near-eye display technology, and more particularly, to a method and a system for correcting nonuniformity of a near-eye display.

### BACKGROUND

Near-eye displays (NEDs) may be provided as an augmented reality (AR) display, a virtual reality (VR) display, a Head Up/Head Mount, or other displays. Generally, an NED usually includes an image generator and optical paths including optical combiners. The image generator is commonly a projector with micro displays (e.g., micro-LED (light-emitting diode), micro-OLED (organic light-emitting diode), LCOS (liquid crystal on silicon), or DLP (digital light processing)) and an integrated optical lens. The optical combiner includes reflective and/or diffractive optics, such as freeform mirror/prism, birdbath, cascaded mirrors, or grating coupler (waveguide). A virtual image is rendered from an NED to human eyes with/without ambient light.

Uniformity is one performance factor for evaluating the imaging quality of an NED. Nonuniformity can be caused by imperfections of display pixels and optical paths to guide the light emitted by the display, and manifests as variation in global distribution, and/or variation in local zones called Mura. A visual artefact may seem like a mottled appearance, a bright spot, a black spot, or a cloudy appearance. For the NEDs such as an AR/VR display, a visual artefact is also observable on the virtual image rendered in the display system. In the virtual image rendered in the AR/VR display, nonuniformity may be shown in luminance and chromaticity. Moreover, the visual artefact caused by nonuniformity is more obvious due to the closeness to human eyes when compared with traditional displays.

Therefore, there is a need for improving the nonuniformity of an NED.

### SUMMARY OF THE DISCLOSURE

Embodiments of the present disclosure provide a method for correcting nonuniformity of an NED. The method includes: generating and displaying a first plurality of test patterns for a display of the NED; obtaining, in response to the first plurality of test patterns, a first plurality of images at an end of an optical path coupled to the display; fitting a mapping relationship for each of display pixels of the display according to the first plurality of test patterns and the first plurality of images, the mapping relationship of a display pixel mapping the display pixel and a corresponding image pixel in each image of the first plurality of images; and determining a correction scheme for correcting nonuniformity of the NED based on the mapping relationship of each of the display pixels.

Embodiments of the present disclosure provide a system for correcting nonuniformity of an NED. The system includes: a light measuring device (LMD) configured to: obtain, in response to a first plurality of test patterns being displayed by a display of the NED, a first plurality of images at an end of an optical path coupled to the display; and a processor configured to: fit a mapping relationship for each of display pixels of the display according to the first plurality of test patterns and the first plurality of images, the mapping relationship of a display pixel mapping the display pixel and a corresponding image pixel in each image of the first plurality of images; and determine a correction scheme for correcting nonuniformity of the NED based on the mapping relationship of each of the display pixels.

Embodiments of the present disclosure provide a non-transitory computer-readable storage medium storing a set of instructions that are executable by one or more processors of a device to cause the device to perform operations for correcting nonuniformity of an NED, the operations including: generating and displaying a first plurality of test patterns for a display of the NED; obtaining, in response to the first plurality of test patterns, a first plurality of images at an end of an optical path coupled to the display; fitting a mapping relationship for each of display pixels of the display according to the first plurality of test patterns and the first plurality of images, the mapping relationship of a display pixel mapping the display pixel and a corresponding image pixel in each image of the first plurality of images; and determining a correction scheme for correcting nonuniformity of the NED based on the mapping relationship of each of the display pixels.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of an exemplary system for correcting nonuniformity of an NED, according to some embodiments of the present disclosure.

FIG. 2 is a schematic diagram of an exemplary VR system according to some embodiments of the present disclosure.

FIG. 3 is a schematic diagram of an exemplary AR system according to some embodiments of the present disclosure.

FIG. 4 illustrates a flowchart of an exemplary method for correcting nonuniformity of an NED, according to some embodiments of the present disclosure.

FIG. 5 illustrates a flowchart of sub-steps of the exemplary method for correcting nonuniformity of an NED shown in FIG. 4, according to some embodiments of the present disclosure.

FIG. 6 illustrates a flowchart of sub-steps of the exemplary method for correcting nonuniformity of an NED shown in FIG. 4, according to some embodiments of the present disclosure.

FIG. 7 illustrates a flowchart of sub-steps of the exemplary method for correcting nonuniformity of an NED shown in FIG. 4, according to some embodiments of the present disclosure.

FIG. 8 illustrates an example of a mapping relationship for mapping between a display pixel and image pixels, according to some embodiments of the present disclosure.

FIG. 9 illustrates an example of an intermediate image, according to some embodiments of the present disclosure.

FIG. 10 illustrates an example of a mapping relationship, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

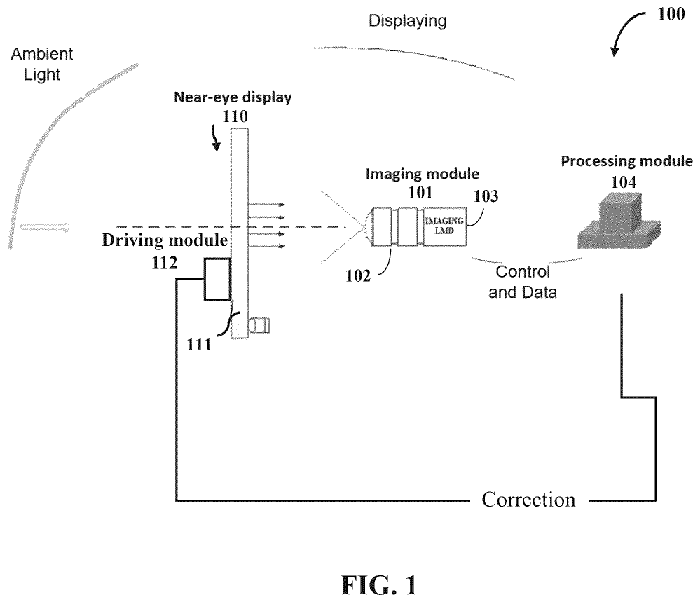

FIG. 1 is a schematic diagram of an exemplary system 100 for correcting nonuniformity of an NED, according to some embodiments of the present disclosure. As shown in FIG. 1, system 100 is used for correcting nonuniformity of a near-eye display (NED) 110. Typically, NED 110 is used for displaying images to human eyes, and NED 110 can be included in an AR device or a VR device, such as a Head-Up/Head-Mount display, a projector, or other displays. In the present disclosure, system 100 is provided for replacing human eyes to evaluate the imaging quality of NED 110 and correct potential nonuniformity accordingly.

In some embodiments, NED 110 includes an image generator 111. Image generator 111 is provided as one or more micro displays (e.g., one display for one eye), such as micro-LED displays, micro-OLED displays, LCOS displays, or DLP displays, and each of the micro displays can be configured as a light engine with an additional projector lens. In some embodiments, the display may be coupled with a plurality of lenses (also referred to as a “lens group”, “designed optics”, etc.) for adjusting the image displayed by the micro display in a manner applicable to human eyes. The micro display of image generator 111 includes a micro light emitting array which can form an active emitting area. The projected image from the light engine through designed optics is transferred to human eyes via an optical path including an optical combiner (not shown). The optics of the optical combiner can be reflective and/or diffractive optics, such as a free form mirror/prism, birdbath, or cascaded mirrors, grating coupler (waveguide), etc.

In some embodiments, a driving module 112, for example, a driver, can be further provided to drive NED 110 for image displaying. Driving module 112 can be coupled to communicate with NED 110, specifically to communicate with image generator 111 of NED 110. That is, driving module 112 can be configured to drive image generator 111 to display an image on the micro displays by driving signals.

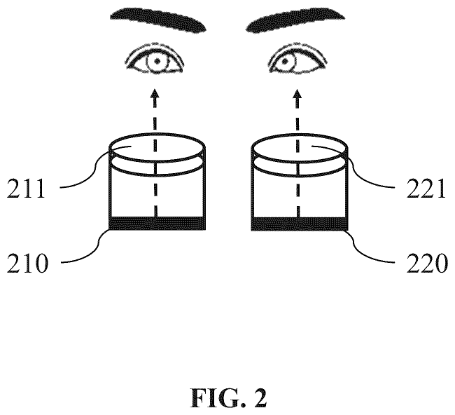

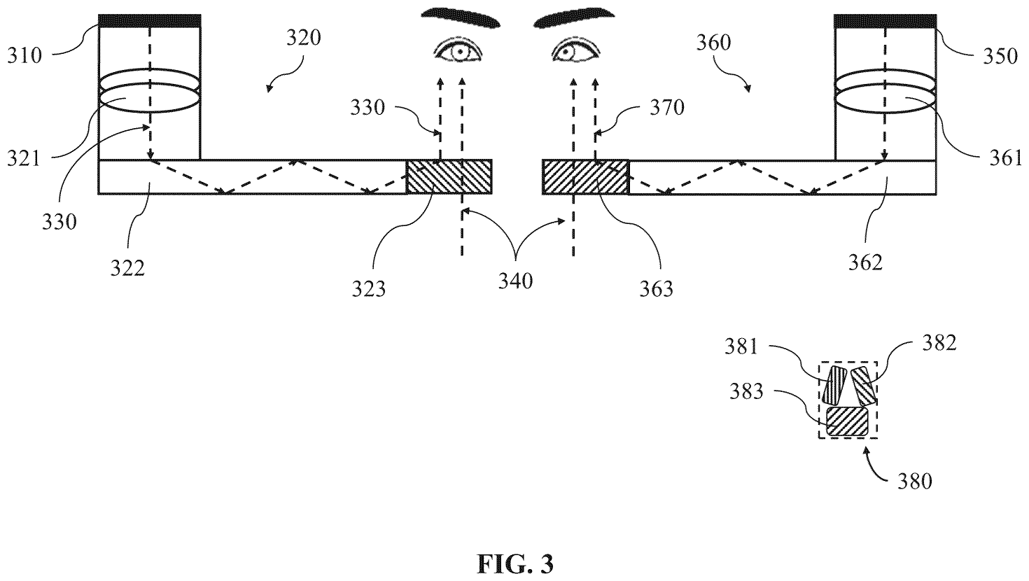

FIG. 2 is a schematic diagram of an exemplary VR system 200 and FIG. 3 is a schematic diagram of an exemplary AR system 300, according to some embodiments of the present disclosure. Referring to FIG. 2, VR system 200 includes a first micro display 210 (e.g., a right display) and a corresponding lens group 211 for adjusting (e.g., magnifying) the image displayed by first micro display 210 in a manner applicable to a viewer's right eye. Similarly, VR system 200 also includes a second micro display 220 (e.g., a left display) and a corresponding lens group 221 for adjusting the image displayed by second micro display 220 in a manner applicable to a viewer's left eye.

It is to be noted that “left” and “right” mentioned in the present disclosure are from the perspective view from a person (i.e., a user or a viewer of system 200) shown in FIG. 2. In the present disclosure, the light path from a micro display to a human eye is also called an optical path, which can include several optical components. That is, lens group 211 and lens group 221 are within respective optical paths and are deemed as optical components of their respective optical paths.

As can be appreciated, first micro display 210 can be used to display a right image, while second micro display 220 can be used to display a left image captured or rendered at a different angle from the right image. When simultaneously viewing the left image and right image, the brain of the viewer combines these two images into a three-dimensional scene. However, if the uniformity within either the left image or the right image is not ideal, a “sense of place” of the three-dimensional scene created by these two images can be affected. The nonuniformity can be caused by one or more of second micro display 220, first micro display 210, lens group 211, or lens group 221. For example, when driven by a signal indicating a same intensity of brightness, some display pixels in either or both of first micro display 210 and second micro display 220 may be brighter compared with the others. In addition, the wavelengths of the three fundamental colors emitted by the display pixels are different, such that the propagation properties in the optical paths thereof are different, which may cause nonuniformity in the images rendered by VR system 200 to human eyes.

Referring to FIG. 3, AR system 300 includes a first micro display 310 (e.g., a right display) and its corresponding optical path 320 for passing the image displayed by first micro display 310 to the right eye of the viewer. As can be seen, optical path 320 includes a lens group 321, a waveguide 322, and an optical combiner 323. Lens group 321 is configured to adjust the image displayed by first micro display 310. Waveguide 322 can be used for directing light 330 emitted from first micro display 310 by several total reflections. Optical combiner 323 directs light 330 emitted from first micro display 310 and may allow ambient light 340 to pass through. Hence, both light 330 and ambient light 340 can reach the right eye of the viewer, and the viewer sees an image to be superimposed on an environment scene. Similarly, AR system 300 also includes a second micro display 350 (e.g., a left display) and its corresponding optical path 360 for passing the image displayed by second micro display 350 to the left eye. Typically, second micro display 350 is of the same resolution as first micro display 310. Optical path 360 includes a lens group 361, a waveguide 362, and an optical combiner 363. As can be appreciated, the viewed images can be affected by anything between the displays and human eyes. That is, the viewed images can be affected by one or more of first micro display 310, second micro display 350, optical path 320, or optical path 360. As described above, the nonuniformity of AR system 300 may be caused by optical path 320 or optical path 360 which may absorb different color components at different intensities. Color cast may occur in the images rendered by AR system 300 to human eyes. When a nonuniformity exists in the viewed images, the imaging effect of AR system 300 deteriorates.

Referring back to FIG. 1, system 100 includes an imaging module 101, for example, an imager, and a processing module 104, for example, a processor. Imaging module 101 is configured to emulate the human eye to measure display optical characteristics and to observe display performance. In some embodiments, imaging module 101 can include a light measuring device (LMD) 103 and a lens 102. For example, LMD 103 can be a colorimeter or an imaging camera, such as a CCD (charge coupled device) or a CMOS (complementary metal oxide semiconductor) image sensor. Lens 102 can be NED lens or normal lens, according to an absolute or relative value measure. Lens 102 of imaging module 101 is provided with a front aperture having a small diameter of, e.g., 1 mm-6 mm. Lens 102 can provide a wide FOV (Field of View) in front, and lens 102 is configured to emulate a human eye to observe NED 110. The optical properties of a virtual image displayed by NED 110 are captured by imaging module 101 and measured by processing module 104.

Processing module 104 is configured to evaluate and improve the uniformity of the virtual image rendered by NED 110. In some embodiments, processing module 104 can be included in a computer or a server. In some embodiments, processing module 104 can be deployed in the cloud, which is not limited herein. In some embodiments, processing module 104 can include one or more processors.

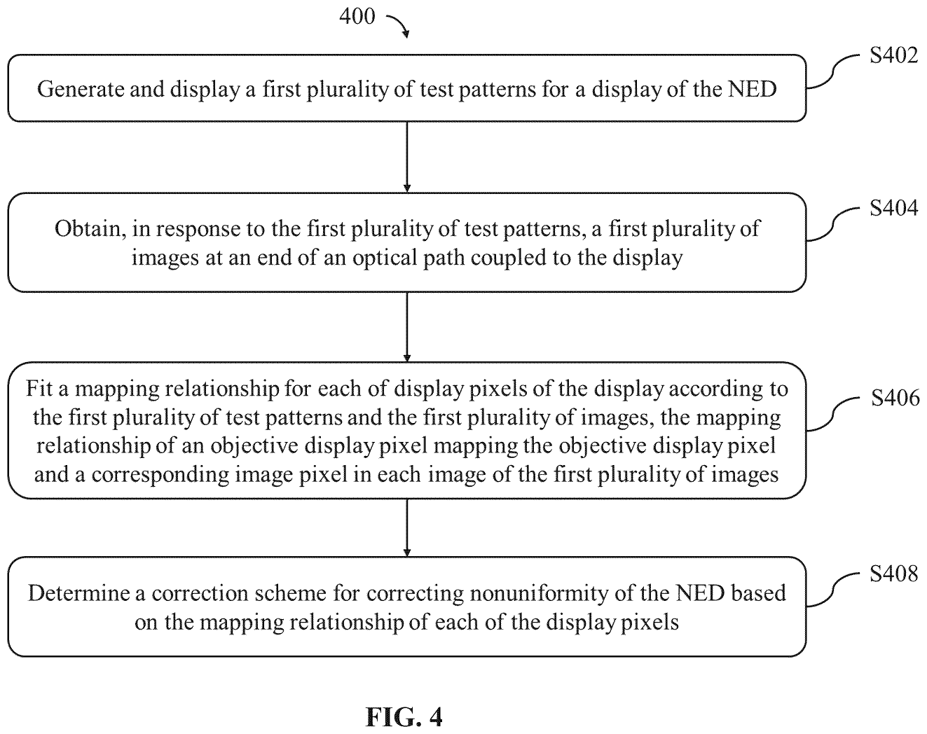

FIG. 4 illustrates a flowchart of an exemplary method 400 for correcting nonuniformity of an NED, according to some embodiments of the present disclosure. The NED can be either a VR system or an AR system as described above with reference to FIGS. 2 and 3, respectively, and the display can be either the first micro display or the second micro display described above. Method 400 includes steps S402 to S408, which can be implemented by a measuring system (such as system 100 in FIG. 1).

At step S402, a first plurality of test patterns is generated for the display of the NED for displaying. For example, with further reference to AR system 300 in FIG. 3, in order to measure the imaging property of a left imaging branch including first micro display 310 and optical path 320 or the imaging property of a right imaging branch including second micro display 350 and optical path 360, a series of test patterns can be generated for first micro display 310 or second micro display 350. In some embodiments, only some color components of the display pixels in first micro display 310 or second micro display 350 need correction. As such, a series of test patterns targeting these color components of display pixels can be generated. For example, a red pattern targeting red display sub-pixels can be generated for correcting nonuniformity caused by red display sub-pixels within a display pixel. For example, if the resolution of first micro display 310 or second micro display 350 is 640×480, then first micro display 310 or second micro display 350 may comprises 640×480 display pixels 380, and each of display pixels 380 may comprise a red sub-pixel 381, a green sub-pixel 382, and a blue sub-pixel 383. In this case, only red sub-pixels 381 of each display pixel 380 within first micro display 310 or second micro display 350 will be lighted by the red pattern.

In the present disclosure, a pixel in a display is referred to as a display pixel intending to distinguish it from an image pixel in an image described below. As appreciated, the display pixel is a hardware component while the image pixel is an imaging representation which can be encoded as a set of data.

In some embodiments, all the display sub-pixels in first micro display 310 or second micro display 350 may need correction. In this situation, the test patterns can be generated for the displays to measure the performance of the displays for different imaging situations. For example, first micro display 310 and second micro display 350 include three kinds of fundamental display sub-pixels, i.e., red display sub-pixels, green display sub-pixels, and blue display sub-pixels, hence complete nonuniformity correction of AR system 300 may need testing of all these display sub-pixels. That is, a first plurality of test patterns can be generated to light all the red display sub-pixels, all the green display sub-pixels, and all the blue display sub-pixels within display pixels for observing the property of these display pixels in a designed sequence. As first micro display 310 and second micro display 350 are typically driven by signals in RGB chroma space, in some embodiments, the first plurality of test patterns can include at least one of: (1) a second plurality of red patterns each corresponding to a red-scale value, for example, red patterns with RGB values of (64, 0, 0), (96, 0, 0), (128, 0, 0), (160, 0, 0), (192, 0, 0), and (224, 0, 0); (2) a third plurality of green patterns each corresponding to a green-scale value, for example, green patterns with RGB values of (0, 64, 0), (0, 96, 0), (0, 128, 0), (0, 160, 0), (0, 192, 0), and (0, 224, 0); or (3) a fourth plurality of blue patterns each corresponding to a blue-scale value, for example, blue patterns with RGB values of (0, 0, 64), (0, 0, 96), (0, 0, 128), (0, 0, 160), (0, 0, 192), and (0, 0, 224). In this manner, the red display sub-pixels, green display sub-pixels, and blue display sub-pixels of first micro display 310 or second micro display 350 can be lighted by the red patterns, the green patterns, and the blue patterns with different intensities (color-scales) in sequence.

As described above, waveguide 322 and optical combiner 323 are provided in optical path 320, while waveguide 362 and optical combiner 363 are provided in optical path 360. The imaging quality of AR system 300 can be affected by optical path 320 or optical path 360. Specifically, at least a part of the nonuniformity in AR system 300 may be caused by optical path 320 or optical path 360. This source of nonuniformity is eliminated or at least reduced with the correction method described herein.

Referring back to FIG. 4, at step S404, in response to the displayed first plurality of test patterns on the display, a first plurality of images is obtained at an end of an optical path coupled to the display. Each of the first plurality of images corresponds to a test pattern. For example, with further reference to FIG. 3, an imaging module (e.g., imaging module 101 in FIG. 1) can be disposed at the end of optical path 320 to capture the right images corresponding to the displayed test patterns shown by first micro display 310. In the present disclosure, the imaging module can be disposed at a distance similar to that between an eye and optical combiner 323 of AR system 300. “At the end” implies that the imaging module is disposed spaced from the end of the optical path and can obtain a full image such as an eye could see. In other words, the imaging module may not be disposed in contact with the end of the optical path. Similarly, another imaging module (e.g., imaging module 101 in FIG. 1) can be disposed at the end of optical path 360 to capture the left images corresponding to the displayed test patterns shown by second micro display 350. In some other embodiments, one imaging module can be used to capture the left image and the right image.

Referring back to FIG. 4, at step S406, a mapping relationship is fitted for each of display pixels of the display according to the first plurality of test patterns and the first plurality of images. The mapping relationship of an objective display pixel (e.g., any display pixel in the display) maps the objective display pixel under study to a corresponding image pixel in each image of the first plurality of images. For example, if the number of the test patterns and the corresponding number of images are N, then the mapping relationship of the objective display pixel can map the objective display pixel displaying N test patterns to N corresponding image pixels, and each image pixel resides in an image. Alternatively, the resolution of the images can be higher than the display resolution, thus the objective display pixel may be mapped to more than one image pixel within an image by the mapping relationship. In this situation, a representative pixel can be selected from these image pixels.

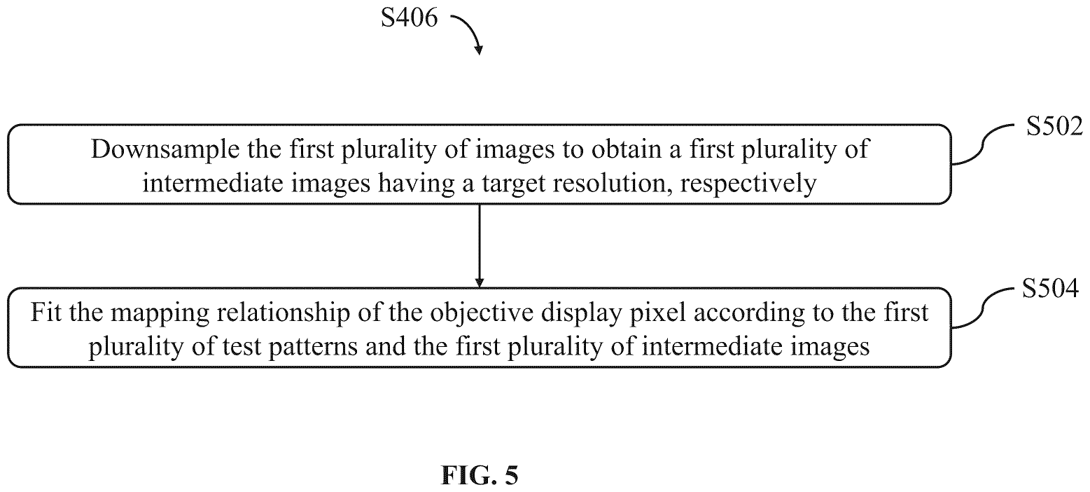

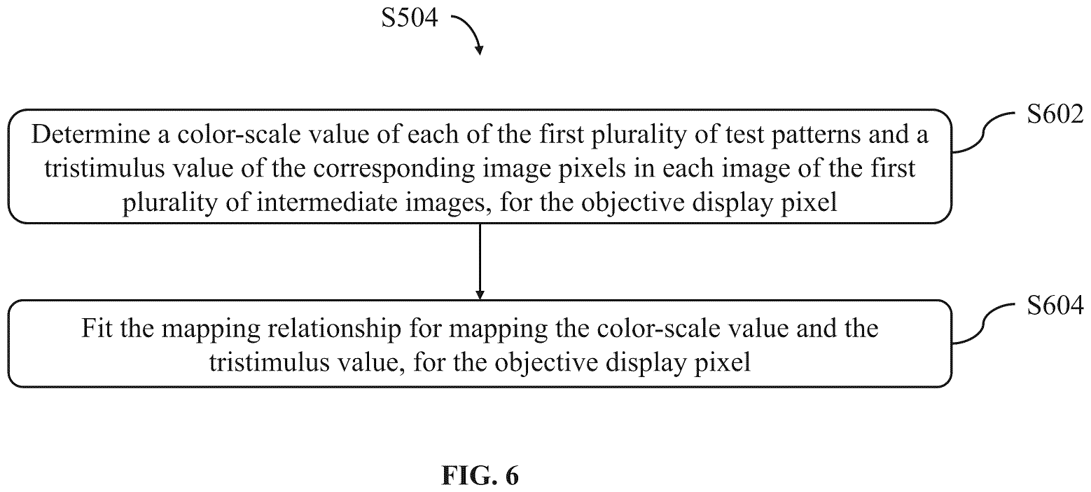

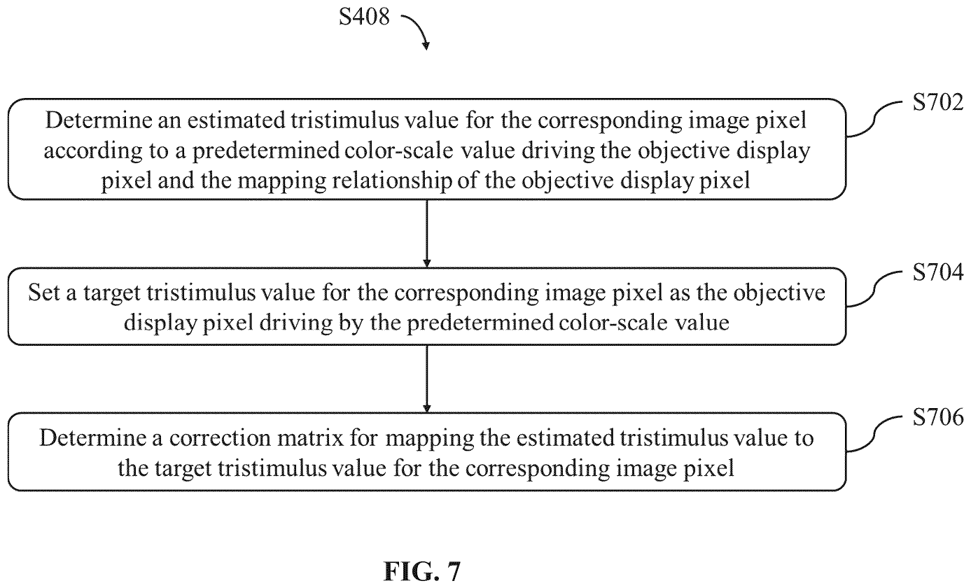

FIG. 5 illustrates a flowchart of sub-steps of method 400 for correcting nonuniformity of an NED, according to some embodiments of the present disclosure. As shown in FIG. 5, step S406 includes sub-steps S502 and S504. FIGS. 6 and 7 also illustrate flowcharts of some sub-steps of method 400, which are described later.

At sub-step S502, the first plurality of images is downsampled to obtain a first plurality of intermediate images having a target resolution. The images captured by an imaging module may have a fine resolution (e.g., 9000×6000), which may be too large for image processing. In some embodiments, the resolution of these images can be lowered by pixel decimation. As used herein, pixel decimation refers to a process by which the number of image pixels in an image is reduced, e.g., downsampled. For example, with further reference to FIG. 3, the target resolution can be set equal to a display resolution of first micro display 310 (or second micro display 350), such as 640×480. In an example, 640×480 pixels out of 9000×6000 pixels from an image are selected to represent the image, which is called an intermediate image. For example, the 9000×6000 pixels are decimated, i.e., reduced in number, in a uniform manner both in the horizontal and vertical directions. In some other examples, the images are scaled in a manner such that a representative pixel is the average of its nearest pixels.

In some embodiments, before downsampling at sub-step S502, the first plurality of images can be pre-processed with image enhancement, image segmentation, or blob analysis to establish a coordinates mapping relationship between the display and the first plurality of images. For example, the display pixel in a relative location of the display (e.g., in ¼ location horizontally and ¾ location vertically) can be mapped to image pixels with the same relative location (e.g., in ¼ location horizontally and ¾ location vertically) in the image.

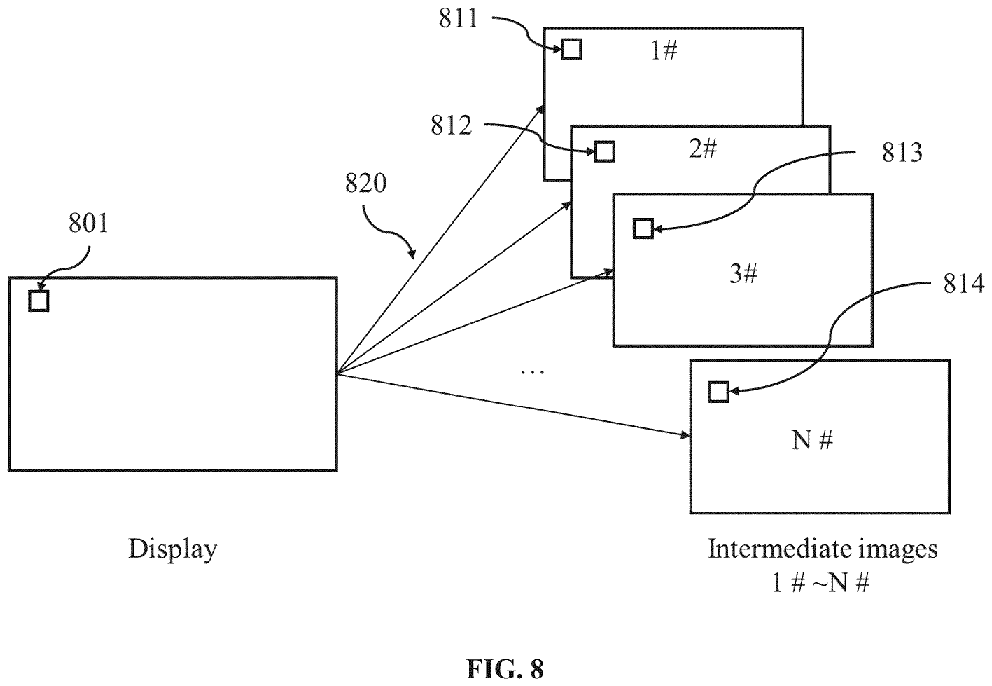

At sub-step S504, the mapping relationship of the objective display pixel is fitted according to the first plurality of test patterns and the first plurality of intermediate images. FIG. 8 illustrates an example of a mapping relationship for mapping between a display pixel and image pixels, according to some embodiments of the present disclosure. As shown in FIG. 8, a mapping relationship 820 of the objective display pixel 801, which is represented by line segments with arrows, can map an objective display pixel 801 in the display to a corresponding image pixel 811 in an intermediate image 1 #, a corresponding image pixel 812 in an intermediate image 2 #, a corresponding image pixel 813 in an intermediate image 3 #, . . . , a corresponding image pixel 814 in an intermediate image N #. As described above, intermediate images 1 # to N # can be of the same resolution as the display, hence objective display pixel 801 in a target location of the display (e.g., with the coordinates of (20, 10)) is mapped to corresponding image pixels 811, 812, 813, . . . , 814 in the target location (e.g., with the coordinates of (20, 10)) of the intermediate images 1 # to N #.

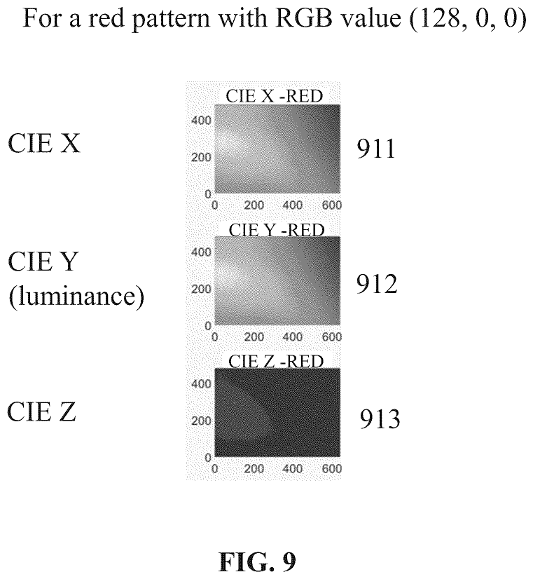

FIG. 9 illustrates an example of an intermediate image, according to some embodiments of the present disclosure. Continuing with the embodiment discussed above, the first plurality of test patterns may include the second plurality of red patterns with RGB values of (64, 0, 0), (96, 0, 0), (128, 0, 0), (160, 0, 0), (192, 0, 0), and (224, 0, 0), the third plurality of green patterns may include green patterns with RGB values of (0, 64, 0), (0, 96, 0), (0, 128, 0), (0, 160, 0), (0, 192, 0), and (0, 224, 0), and the fourth plurality of blue patterns may include blue patterns with RGB values of (0, 0, 64), (0, 0, 96), (0, 0, 128), (0, 0, 160), (0, 0, 192), and (0, 0, 224) in RGB chroma space. These patterns can be displayed in sequence. For example, when a red pattern with RGB value (128, 0, 0) is displayed on the display (e.g., first micro display 310 or second micro display 350 in FIG. 3), an image can be obtained by the imaging module (e.g., imaging module 101 in FIG. 1). In some embodiments, the image is represented in CIE (Commission Internationale de l'Eclairage, or International Commission on illumination) XYZ chroma space. As a result, the intermediate image is represented in XYZ chroma space as well. Hence, the intermediate image can be decomposed into CIE X components, CIE Y components, and CIE Z components. As shown in FIG. 9, an image 911 represents the intermediate image based on the red pattern with RGB value (128, 0, 0) represented in CIE X components, an image 912 represents the intermediate image based on the red pattern with RGB value (128, 0, 0) represented in CIE Y (luminance) components, and an image 913 represents the intermediate image based on the red pattern with RGB value (128, 0, 0) represented in CIE Z components. For the red pattern with RGB value (128, 0, 0), image 911 may show a greater intensity compared to images 912 and 913.

The method described above to form the intermediate images can also be applied to the green patterns and the blue patterns, and three images representing intermediate images in CIE X components, CIE Y (luminance) components and CIE Z components will be generated respectively, which is not repeated here. In the present disclosure, although images denotated as “CIE X-RED” and “CIE Z-RED” are used to represent imaging chroma components, they can be expressed in a tristimulus showing the intensity of X and Z components of each image pixel. In some embodiments, the first plurality of images and the first plurality of intermediate images are represented by tristimulus values.

FIG. 6 illustrates a flowchart of sub-steps of method 400 for correcting nonuniformity of an NED, according to some embodiments of the present disclosure. As shown in FIG. 6, step S504 includes sub-steps S602 and S604.

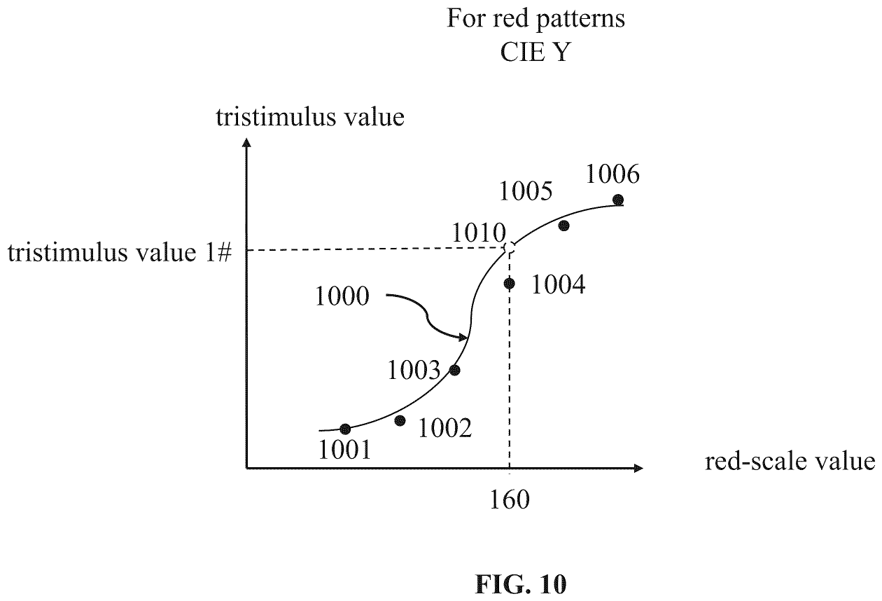

At sub-step S602, a color-scale value of each of the first plurality of test patterns and a tristimulus value of the corresponding image pixel in each image of the first plurality of intermediate images are determined for the objective display pixel. FIG. 10 illustrates an example of a mapping relationship, according to some embodiments of the present disclosure. As shown in FIG. 10, for red patterns with RGB values of (64, 0, 0), (96, 0, 0), (128, 0, 0), (160, 0, 0), (192, 0, 0), and (224, 0, 0), the determined color-scale values (i.e., red-scale values) are 64, 96, 128, 160, 192, and 224. These red patterns with the above-noted color-scale values are generated from the objective display pixel and other display pixels in the display. Consequently, for the red pattern with the color-scale value of 64, for example, the tristimulus values of CIE Y components of the corresponding image pixel of the objective display pixel in the intermediate image is 45. Similarly, for the red patterns with the color-scale values of 96, 128, 160, 192, and 224, the tristimulus values of the corresponding image pixels in the intermediate images are 50, 110, 170, 205, and 225, respectively. Once the color-scale values and the corresponding tristimulus values are determined, the color-scale values and the corresponding tristimulus values can be used to draw points in a coordinate system in which the abscissa is the color-scale value and the ordinate is the tristimulus value. For example, point 1001 with coordinates of (64, 45), point 1002 with coordinates of (96, 50), point 1003 with coordinates of (128, 110), point 1004 with coordinates of (160, 170), point 1005 with coordinates of (192, 205), and point 1006 with coordinates of (224, 225) can be drawn in this coordinate system.

Referring back to FIG. 6, at sub-step S604, the mapping relationship for mapping the color-scale value and the tristimulus value is fitted for the objective display pixel. In some embodiments, the mapping relationship can be a mathematical expression, a lookup table, or a curve. For example, the mapping relationship can be a curve 1000 shown in FIG. 10, which is fitted according to points 1001, 1002, 1003, 1004, 1005, and 1006. In some embodiments, not all the points 1001, 1002, 1003, 1004, 1005, and 1006 are on curve 1000.

In some embodiments, the mapping relationship can also be fitted with a mathematical expression form:

$$y = {\sum }_{i = 0}^{n} {a}_{i} {x}^{i} + {c ( \frac{x}{255} )}^{γ} \qquad ( 1 )$$

where, x is the color-scale value of the objective display pixel corresponding to a test pattern, y is the tristimulus value of the corresponding image pixel in the intermediate image corresponding to the test pattern, and aᵢ (i=1, . . . , n), c and γ are the coefficients of the expression which can be zero but cannot all be zero at the same time. As can be appreciated, once the mapping relationship of the objective display pixel is determined, the tristimulus value of the corresponding image pixel in the intermediate image corresponding to a test pattern with a color-scale value can be estimated according to the mapping relationship.

As also can be appreciated, FIG. 10 illustrates an exemplary mapping relationship of CIE Y components corresponding to some red patterns, and the mapping principle of which can also be applied to CIE X and CIE Z components corresponding to these red patterns, if necessary. Similarly, this mapping principle can also be applied to CIE X, CIE Y and CIE Z components corresponding to green patterns and blue patterns. In this manner, the mapping relationship may comprise several mathematical expressions, lookup tables, or curves.

Referring back to FIG. 4, at step S408, a correction scheme is determined for correcting nonuniformity of the NED based on the mapping relationship of each of the display pixels. It is appreciated that the mapping relationship in the present disclosure is generated according to several test patterns, so the electrical characteristics of the display pixels are measured in a more reliable way compared with traditional ones. Hence, the correction scheme based on the mapping relationship will reflect the actual performance of different display pixels.

FIG. 7 illustrates a flowchart of sub-steps of method 400 for correcting nonuniformity of an NED, according to some embodiments of the present disclosure. As shown in FIG. 7, step S408 includes sub-steps S702 to S706.

At sub-step S702, an estimated tristimulus value for the corresponding image pixel is determined according to a predetermined color-scale value driving the objective display pixel and the mapping relationship of the objective display pixel. Referring to FIG. 10, for example, if the mapping relationship of the objective display pixel corresponding to red patterns is determined as curve 1000 shown in FIG. 10, then the estimated tristimulus value (i.e., tristimulus value 1 #) for the corresponding image pixel corresponding to the predetermined color-scale value (i.e., red-scale value=160) driving the objective display pixel can be determined according to curve 1000, wherein point 1010 with coordinates of (160, tristimulus value 1 #) is on curve 1000. The method described above to determine an estimated tristimulus value can also be applicable to the green patterns or the blue patterns, which is not repeated here.

At sub-step S704, a target tristimulus value for the corresponding image pixel is set for the objective display pixel driven by the predetermined color-scale value. The target tristimulus value can be set according to a distribution of the tristimulus values of the image pixels in an image of the first plurality of intermediate images. In some embodiments, the target tristimulus value is an average tristimulus value of each image pixel in the intermediate image. In some other embodiments, the target tristimulus value is the tristimulus value with a greatest probability in the distribution. A target value generally reflects a statistical status of the intermediate image, and can be used to represent the intermediate image.

Referring to FIG. 9, the luminance (CIE Y components) and chromaticity (CIE X and CIE Z components) distribution and uniformity for the objective display pixel driven by a red pattern with the predetermined RGB value (128, 0, 0) can be achieved for the intermediate image. Then, the target luminance and target chromaticity for the display (i.e., for all the image pixels including the corresponding image pixel of the objective display pixel) can be determined based on the intermediate image. For example, as described above, the target luminance can be calculated with consideration of the average value of all image pixels or the value at a maximum in a probability distribution. The target chromaticity can be determined from the distribution of chromaticity (e.g., the distribution of CIE X and CIE Z components). The target chromaticity may also consider the white point or a standard color temperature (e.g., D65 or D55), and the color temperature of the target chromaticity can be shifted toward the standard color temperature. Once the target tristimulus values of CIE X, CIE Y, and CIE Z are determined, the target for correction for each display pixel in the display is set, which can be represented as the following target tristimulus value matrix [M_{3×3}]_{obj}:

$${[ {M}_{3 X 3} ]}_{obj} = {[ \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ]}_{obj} \qquad ( 2 )$$

In this 3×3 matrix, X_{R} represents the target tristimulus value of chroma components X corresponding to a predetermined red pattern with a predetermined red-scale value, Y_{G} represents the target tristimulus value of luminance components Y corresponding to a predetermined green pattern with a predetermined green-scale value, Z_{B} represents the target tristimulus value of chroma components Z corresponding to a predetermined blue pattern with a predetermined blue-scale value, etc. As can be understood, this matrix implements both luminance correction and chromaticity correction. If only the luminance correction is needed to be applied, then only the second row [Y_{R} Y_{G} Y_{B}]_{obj} needs to be determined, and this matrix become a 1×3 matrix.

Referring back to FIG. 7, at sub-step S706, a correction matrix for mapping the estimated tristimulus value to the target tristimulus value is determined for the corresponding image pixel, wherein the correction matrix can be applied to the driving signal to correct the nonuniformity of the display of an NED. It is appreciated that the correction matrix can be also deemed as corresponding to the objective display pixel of the corresponding image pixel. In some embodiments, the red patterns, the green patterns, and the blue patterns contribute to form a part of the correction matrix. As mentioned above, a correction matrix [M_{3×3}]_{corr} is used for mapping the estimated tristimulus value of the corresponding image pixel in the intermediate image represented in CIE XYZ [M_{3×3}]ₚₓ to the target tristimulus value [M_{3×3}]_{obj}, hence this process can be represented by the following formula:

$${{[ {M}_{3 X 3} ]}_{px} [ {M}_{3 X 3} ]}_{corr} = {[ {M}_{3 X 3} ]}_{obj} \qquad ( 3 )$$

in which, [M_{3×3}]ₚₓ can be in the form of:

$${[ {M}_{3 X 3} ]}_{px} = {[ \begin{matrix}{X}_{Re} & {X}_{Ge} & {X}_{Be} \\ {Y}_{Re} & {Y}_{Ge} & {Y}_{Be} \\ {Z}_{Re} & {Z}_{Ge} & {Z}_{Be}\end{matrix} ]}_{px} \qquad ( 4 )$$

wherein, X_{Re} represents the estimated tristimulus value of chroma components X corresponding to the predetermined red pattern with the predetermined red-scale value, Y_{Ge} represents the estimated tristimulus value of luminance components Y corresponding to the predetermined green pattern with the predetermined green-scale value, Z_{B} represents the estimated tristimulus value of chroma components Z corresponding to the predetermined blue pattern with the predetermined blue-scale value, etc.

In other words, the correction matrix can be

$${[ {M}_{3 X 3} ]}_{c o r r} = {[ \begin{matrix}{α}_{r} & {α}_{g} & {α}_{b} \\ {β}_{r} & {β}_{g} & {β}_{b} \\ {μ}_{r} & {μ}_{g} & {μ}_{b}\end{matrix} ]}_{corr}$$

determined through the following equation:

$${[ {M}_{3 X 3} ]}_{corr} = {{[ {M}_{3 X 3} ]}_{px}^{′} [ {M}_{3 X 3} ]}_{obj} \qquad ( 5 )$$

wherein, [M_{3×3}]ₚₓ′ denotes the inverse of matrix [M_{3×3}]ₚₓ, and [M_{3×3}]ₚₓ contains the estimated tristimulus values that can be determined at sub-step S702. As appreciated, [M_{3×3}]_{corr} can be generated for each of the 640×480 pixels.

In some embodiments, gamma operation in a driving system (e.g., driving module 112 in FIG. 1) can also be considered when determining the correction scheme. For example, the correction matrix can be updated by a gamma operator γ for each image pixel in the intermediate image:

$${[ {M}_{3 X 3} ]}_{corr \_ 2} = {[ {M}_{3 X 3} ]}_{corr}^{1 / γ} = [ \begin{matrix}{α}_{r}^{\frac{1}{γ}} & {α}_{g}^{\frac{1}{γ}} & {α}_{b}^{\frac{1}{γ}} \\ {β}_{r}^{\frac{1}{γ}} & {β}_{g}^{\frac{1}{γ}} & {β}_{b}^{\frac{1}{γ}} \\ {μ}_{r}^{\frac{1}{γ}} & {μ}_{g}^{\frac{1}{γ}} & {μ}_{b}^{\frac{1}{γ}}\end{matrix} ] \qquad ( 6 )$$

When [M_{3×3}]_{corr_2} is applied for correction, the driving system (e.g., driving module 112 in FIG. 1) of the display will not conduct another gamma correction to the display pixels.

In some embodiments, the determined correction matrix can be saved for further processing. In some other embodiments, the determined correction matrix for each image pixel in the intermediate image can be used to update the driving system of the display according to the correction matrix. The driving system can drive the display with their corresponding driver files. For example, when a display pixel of the display is driving a signal

$$[ \begin{matrix}{r}_{in} \\ {g}_{in} \\ {b}_{in}\end{matrix} ]$$

in RGB chroma space, the drives can correct this driving signal to

$$[ \begin{matrix}{r}_{out} \\ {g}_{out} \\ {b}_{out}\end{matrix} ] = {[ {M}_{3 X 3} ]}_{corr} \times [ \begin{matrix}{r}_{in} \\ {g}_{in} \\ {b}_{in}\end{matrix} ] ,$$

which is actually used to drive the display pixel. When considering gamma operation, the drive can instead correct this driving signal to

$$[ \begin{matrix}{r}_{out} \\ {g}_{out} \\ {b}_{out}\end{matrix} ] = {[ {M}_{3 X 3} ]}_{corr \_ 2} \times [ \begin{matrix}{r}_{in} \\ {g}_{in} \\ {b}_{in}\end{matrix} ] .$$

To review the quality of improvement with the correction scheme, the uniformity of the display can be evaluated before and after correction. In some embodiments, the method for correcting nonuniformity further includes the following steps (not shown): displaying the test pattern on the display with the updated driver files; and verifying an updated uniformity of the display according to an updated image corresponding to the test pattern.

Some embodiments of the present disclosure further provide a non-transitory computer-readable storage medium storing a set of instructions that are executable by one or more processors of a device to cause the device to perform any of the above-mentioned methods for correcting nonuniformity of an NED.

It should be noted that relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequences of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for correcting nonuniformity of a near-eye display (NED), comprising:
generating and displaying a first plurality of test patterns for a display of the NED;
obtaining, in response to the first plurality of test patterns, a first plurality of images at an end of an optical path coupled to the display;
fitting a mapping relationship for each of display pixels of the display according to the first plurality of test patterns and the first plurality of images, the mapping relationship of a display pixel mapping the display pixel and a corresponding image pixel in each image of the first plurality of images; and
determining a correction scheme for correcting nonuniformity of the NED based on the mapping relationship of each of the display pixels.

2. The method according to claim 1, wherein at least a part of the nonuniformity is caused by the optical path.

3. The method according to claim 1, wherein fitting the mapping relationship for each of the display pixels of the display according to the first plurality of test patterns and the first plurality of images comprises:
downsampling the first plurality of images to obtain a first plurality of intermediate images having a target resolution, respectively; and
fitting the mapping relationship of the display pixel according to the first plurality of test patterns and the first plurality of intermediate images.

4. The method according to claim 3, wherein the target resolution is equal to a display resolution of the display, and the display pixel in a target location of the display is mapped to the corresponding image pixel in the target location in each image of the first plurality of intermediate images.

5. The method according to claim 4, wherein the first plurality of test patterns is in an RGB chroma space, and comprises at least one of a second plurality of red patterns each corresponding to a red-scale value, a third plurality of green patterns each corresponding to a green-scale value, or a fourth plurality of blue patterns each corresponding to a blue-scale value.

6. The method according to claim 5, wherein the first plurality of images and the first plurality of intermediate images are represented by tristimulus values.

7. The method according to claim 6, wherein fitting the mapping relationship of the display pixel according to the first plurality of test patterns and the first plurality of intermediate images comprises:
determining a color-scale value of each of the first plurality of test patterns and a tristimulus value of the corresponding image pixel in each image of the first plurality of intermediate images, for the display pixel; and
fitting the mapping relationship for mapping the color-scale value and the tristimulus value, for the display pixel.

8. The method according to claim 7, wherein the mapping relationship is a mathematical expression, a lookup table, or a curve.

9. The method according to claim 4, wherein determining the correction scheme for correcting nonuniformity of the NED based on the mapping relationship of each of the display pixels comprises:
determining an estimated tristimulus value for the corresponding image pixel according to a predetermined color-scale value driving the display pixel and the mapping relationship of the display pixel;
setting a target tristimulus value for the corresponding image pixel as the display pixel driven by the predetermined color-scale value; and
determining a correction matrix for mapping the estimated tristimulus value to the target tristimulus value for the corresponding image pixel.

10. The method according to claim 9, wherein the target tristimulus value is set according to a distribution of the tristimulus values of the image pixels in an image of the first plurality of intermediate images.

11. The method according to claim 10, wherein the target tristimulus value is an average tristimulus value of each image pixel in the image of the first plurality of intermediate images, or the target tristimulus value is the tristimulus value with a greatest probability in the distribution.

12. The method according to claim 9, wherein determining the correction scheme for correcting nonuniformity of the NED based on the mapping relationship of each of the display pixels further comprises:
updating, for the corresponding image pixel, the correction matrix by a gamma operator.

13. The method according to claim 9, wherein the display comprises a driver to drive display of an image, the method further comprising:
updating the driver of the display according to the correction matrix of each image pixel.

14. The method according to claim 1, wherein the first plurality of images is represented in an XYZ chroma space.

15. A system for correcting nonuniformity of a near-eye display (NED), comprising:
a light measuring device (LMD) configured to:
obtain, in response to a first plurality of test patterns being displayed by a display of the NED, a first plurality of images at an end of an optical path coupled to the display; and
a processor configured to:
fit a mapping relationship for each of display pixels of the display according to the first plurality of test patterns and the first plurality of images, the mapping relationship of a display pixel mapping the display pixel and a corresponding image pixel in each image of the first plurality of images; and
determine a correction scheme for correcting nonuniformity of the NED based on the mapping relationship of each of the display pixels.

16. The system according to claim 15, wherein the processor is further configured to generate the first plurality of test patterns for the display.

17. The system according to claim 15, wherein at least a part of the nonuniformity is caused by the optical path.

18. The system according to claim 15, wherein the processor is further configured to:
downsample the first plurality of images to obtain a first plurality of intermediate images having a target resolution, respectively; and
fit the mapping relationship of the display pixel according to the first plurality of test patterns and the first plurality of intermediate images.

19. The system according to claim 18, wherein the target resolution is equal to a display resolution of the display, and the display pixel in a target location of the display is mapped to the corresponding image pixel in the target location in each image of the first plurality of intermediate images.

20. The system according to claim 19, wherein the first plurality of test patterns is in an RGB chroma space and comprises at least one of a second plurality of red patterns each corresponding to a red-scale value, a third plurality of green patterns each corresponding to a green-scale value, or a fourth plurality of blue patterns each corresponding to a blue-scale value.

21. The system according to claim 20, wherein the first plurality of images and the first plurality of intermediate images are represented by tristimulus values.

22. The system according to claim 21, wherein the processor is further configured to:
determine a color-scale value of each of the first plurality of test patterns and a tristimulus value of the corresponding image pixel in each image of the first plurality of intermediate images, for the display pixel; and
fit the mapping relationship for mapping the color-scale value and the tristimulus value, for the display pixel.

23. The system according to claim 18, wherein the processor is further configured to:
determine an estimated tristimulus value for the corresponding image pixel according to a predetermined color-scale value driving the display pixel and the mapping relationship of the display pixel;
set a target tristimulus value for the corresponding image pixel as the display pixel driven by the predetermined color-scale value; and
determine a correction matrix for mapping the estimated tristimulus value to the target tristimulus value for the corresponding image pixel.

24. The system according to claim 23, wherein the display comprises a driver to drive display of an image, the processor being further configured to update the driver of the display according to the correction matrix of each image pixel.

25. A non-transitory computer-readable storage medium storing a set of instructions that are executable by one or more processors of a device to cause the device to perform operations for correcting nonuniformity of a near-eye display (NED), the operations comprising:
generating and displaying a first plurality of test patterns for a display of the NED;
obtaining, in response to the first plurality of test patterns, a first plurality of images at an end of an optical path coupled to the display;
fitting a mapping relationship for each of display pixels of the display according to the first plurality of test patterns and the first plurality of images, the mapping relationship of a display pixel mapping the display pixel and a corresponding image pixel in each image of the first plurality of images; and
determining a correction scheme for correcting nonuniformity of the NED based on the mapping relationship of each of the display pixels.
